(19) United States
(12) Patent Application Publication
(10) Pub. No.: US 2020/0191597 A1
(43) Pub. Date: Jun. 18, 2020

(54) TRAVEL GUIDE SYSTEM AND COMPUTER PROGRAM

(71) Applicant: TOYOTA JIDOSHA KABUSHIKI KAISHA, Toyota-shi (JP)

(72) Inventors: Yoko SAKURAI, Anjo-shi (JP); Toru SAKAMOTO, Anjo-shi (JP); Xin JIN, Nagoya-shi (JP)

(73) Assignee: TOYOTA JIDOSHA KABUSHIKI KAISHA, Toyota-shi (JP)

(21) Appl. No.: 16/715,675

(22) Filed: Dec. 16, 2019

(30) Foreign Application Priority Data
Dec. 18, 2018 (JP) 2018-236120

(51) Int. Cl. G01C 21/36

(52) U.S. Cl. CPC G01C 21/3644

(57) ABSTRACT

It is configured that, in the case where a vehicle travel guide along a guide route is provided and where the vehicle passes a guide intersection along the guide route, an entry road, from which the vehicle enters the guide intersection, and a leaving road, through which the vehicle leaves the guide intersection, are specified, and a mark used for the travel guide at the guide intersection is determined on the basis of at least one of a road structure of the entry road and a road structure of the leaving road.

### INCORPORATION BY REFERENCE

The disclosure of Japanese Patent Application No. 2018-236120 filed on Dec. 18, 2018 including the specification, drawings and abstract is incorporated herein by reference in its entirety.

### BACKGROUND

### 1. Technical Field

The disclosure relates to a travel guide system and a computer program that provide a travel guide using a mark.

### 2. Description of Related Art

In recent years, a navigation system that provides a vehicle travel guide so as to allow a driver to easily arrive at a desired destination is frequently mounted on vehicles. Here, the navigation system is a system that detects a current location of a host vehicle using a GPS receiver or the like, acquires map data corresponding to the current location through a recording medium such as a DVD-ROM or a HDD, or a network, and can display the map data on a liquid crystal display. Furthermore, such a navigation system has a route search function of searching an optimum route from a point of departure to the destination when the desired destination is entered. Then, the guide route that is set on the basis of a search result is presented on a display screen, and, in the case where the vehicle approaches an intersection, a guide of which, such as a right or left turn, is provided (hereinafter referred to as a guide intersection), an audio guide and/or a guide using the display screen is provided so as to reliably guide a user to the desired destination. In addition, mobile telephones, smartphones, tablet terminals, personal computers, and the like with the same function as the navigation system are available in recent years. Furthermore, such a guide can be provided for targets other than the vehicle such as a pedestrian and a two-wheeled vehicle.

By the way, when the guide such as the right or left turn is provided at the guide intersection, it is important for the user to accurately identify the guide intersection. Thus, the guide has conventionally been provided using a facility, a building, or the like that serves as a mark at the guide intersection. In the case where the guide of the guide intersection is provided using such a mark, it is important that the user can visually recognize the mark when being guided. For example, in Japanese Patent Application Publication No. 2014-163814(JP 2014-163814A), a technique of detecting a position of a line of sight of the user at the time when the guide of the guide intersection is provided, so as to detect whether the user can visually recognize the mark, highly evaluating suitability of the mark, the visual recognition of which by the user is detected, and preferentially using such a mark in the future guides is disclosed.

### SUMMARY

However, visibility of the same mark by the user is not always the same and is significantly influenced by a peripheral road structure. For example, the visibility of the mark greatly differs between a case where an entry road heading for the guide intersection is a downhill road and a case where the entry road heading for the guide intersection is an uphill road even when the same mark is provided at the same intersection. Similarly, the visibility of the mark greatly differs between a case where a median strip exists between the user and the mark and a case where the median strip does not exist therebetween even when the same mark is provided at the same intersection.

In JP 2014-163814A described above, the peripheral road structure as described above is not taken into consideration. Thus, even the highly suitable mark may not be easily recognized by the user depending on a direction to enter the guide intersection or a direction to leave from the guide intersection.

The disclosure has been made to solve the conventional problem and therefore has a purpose of providing a travel guide system and a computer program capable of considering visibility of a mark on the basis of a peripheral road structure at a guide intersection and thus providing a travel guide of the guide intersection by using the further appropriate mark.

A travel guide system according to the disclosure for achieving the above purpose is a travel guide system that provides a movable object with a travel guide at a guide intersection by using a mark located around a travel route of the movable object, and includes: a road specifying unit that specifies an entry road, from which the movable object enters the guide intersection, and a leaving road, through which the movable object leaves the guide intersection, in the case where the movable object passes the guide intersection along the travel route; and a mark determination unit that determines the mark used for the travel guide at the guide intersection on the basis of at least one of a road structure of the entry road and a road structure of the leaving road. Here, the “movable object” includes a pedestrian (the user himself/herself) and a two-wheeled vehicle in addition to the vehicle.

A computer program according to the disclosure is a program that provides a movable object with a travel guide at a guide intersection by using a mark located around a travel route of the movable object. The computer program makes a computer function as: a road specifying unit that specifies an entry road, from which the movable object enters the guide intersection, and a leaving road, through which the movable object leaves the guide intersection, in the case where the movable object passes the guide intersection along the travel route; and a mark determination unit that determines the mark used for the travel guide at the guide intersection on the basis of at least one of a road structure of the entry road and a road structure of the leaving road.

In the travel guide system and the computer program having the above configurations according to the disclosure, the mark used for the travel guide at the guide intersection is determined on the basis at least one of the road structure of the entry road and the road structure of the leaving road at the time when the movable object passes the guide intersection. Thus, it is possible to determine the mark in consideration of visibility of the mark based on the road structure of the road around the guide intersection. As a result, it is possible to provide the travel guide of the guide intersection using the further appropriate mark.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating a navigation system according to an embodiment;

FIG. 2 is a table illustrating examples of mark data;

FIG. 3 is a view illustrating a positional relationship between a guide intersection and mark candidates;

FIG. 4 is a flowchart of a travel guide processing program according to this embodiment;

FIG. 5 is a flowchart of a sub-processing program for guide information generation processing according to this embodiment;

FIG. 6 is a view illustrating selection priority orders of guide marks at the guide intersection with fair visibility;

FIG. 7 is a view illustrating a guide example in the case where a guide of the guide intersection is provided using the guide mark around the guide intersection with the fair visibility;

FIG. 8 is a view illustrating the selection priority orders of the guide marks at the guide intersection with the normal visibility;

FIG. 9 is a view illustrating a guide example in the case where the guide of the guide intersection is provided using the guide mark around the guide intersection with the normal visibility;

FIG. 10 is a view illustrating a selection example of the guide mark at the guide intersection on the basis of road structures of an entry road and a leaving road (particularly during a right turn); and

FIG. 11 is a view illustrating a selection example of the guide mark at the guide intersection on the basis of the road structures of the entry road and the leaving road (particularly during a left turn).

### DETAILED DESCRIPTION OF EMBODIMENTS

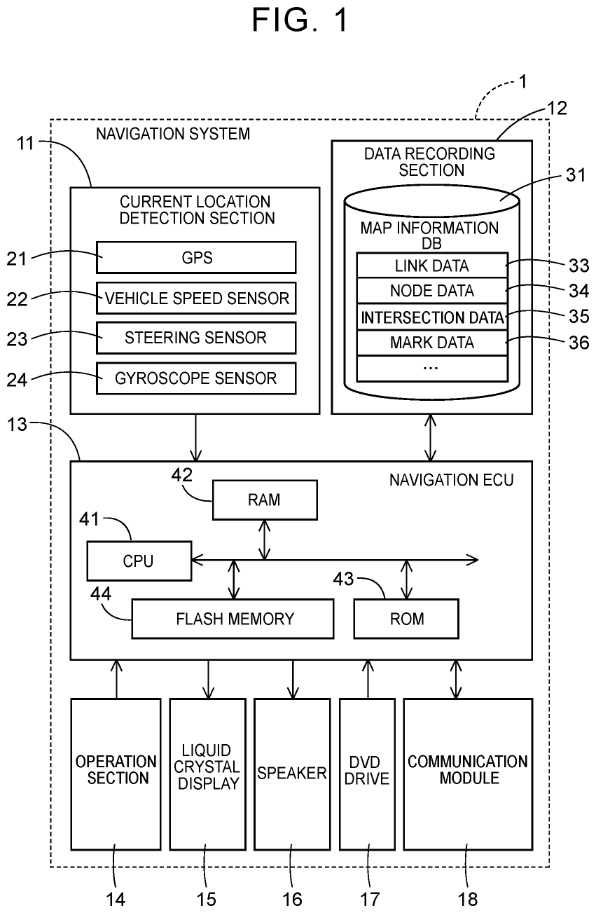

A detailed description will hereinafter be made on an embodiment in which a travel guide system according to the disclosure is embodied as a navigation system with reference to the drawings. First, a description will be made on a schematic configuration of a navigation system 1 according to this embodiment with reference to FIG. 1. FIG. 1 is a block diagram illustrating the navigation system 1 according to this embodiment.

As illustrated in FIG. 1, the navigation system 1 according to this embodiment includes: a current location detection section 11 that detects a current location of a vehicle on which the navigation system 1 is mounted; a data recording section 12 in which various types of data are recorded; a navigation electronic control unit (ECU) 13 that executes various types of calculation processing on the basis of input information; an operation section 14 that accepts an operation from a user; a liquid crystal display 15 that displays a map and a guide route to a destination for the user; a speaker 16 that outputs audio guidance related to a route guide; a DVD drive 17 that reads a DVD as a storage medium; and a communication module 18 that communicates with an information center such as a probe center or Vehicle Information and Communication System (VICS®) center.

A description will hereinafter be made on each of the components provided in the navigation system 1 in an order. The current location detection section 11 includes a GPS 21, a vehicle speed sensor 22, a steering sensor 23, a gyroscope sensor 24, and the like and can detect the current vehicle location, an orientation, a travel speed of the vehicle, current time, and the like. Here, particularly, the vehicle speed sensor 22 is a sensor used to detect a travel distance of the vehicle and a vehicle speed, generates pulses according to rotation of drive wheels of the vehicle, and outputs a pulse signal to the navigation ECU 13. Then, the navigation ECU 13 counts the generated pulses so as to calculate a speed of each of the drive wheels and the travel distance. The navigation system 1 does not have to include all of the four sensors described above. The navigation system 1 may be configured to include only one or some of these sensors.

The data recording section 12 includes: a hard disk (not illustrated) as an external storage device and the recording medium; and a recording head (not illustrated) as a driver that reads a map information DB 31, a specified program, and the like recorded in the hard disk and writes specified data in the hard disk. Here, instead of the hard disk, the data recording section 12 may be constructed of non-volatile memory, a memory card, or an optical disc such as a CD or the DVD. In addition, the map information DB 31 may be configured to be stored in an external server and acquired by the navigation system 1 via communication.

The map information DB 31 is a storage in which link data 33 on roads (links), node data 34 on node points, intersection data 35 on each intersection, mark data 36 on marks, point data on points such as a facility, map display data used to display the map, search data used to search for the route, lookup data used to look up the point, and the like, for example, are stored.

Here, as the link data 33, for example, a link ID used to identify the link, end node information that specifies the node at an end of the link, a road type of the road constituting the link, a road structure, and the like are stored. As the node data 34, a node ID that identifies the node, location coordinates of the node, connection destination node information that specifies a connection destination node to which the node is connected via the link, and the like are stored. As the intersection data 35, corresponding node information that specifies the node forming the intersection, connection link information that specifies the link connected to the intersection (hereinafter referred to as a connection link), information that specifies a shape of the intersection, and the like are stored.

Information on the road structure of the road included in the link data 33 includes information that specifies a “shape of the road”, a “gradient”, the “number of lanes”, and “presence or absence of a median strip”. As the “shape of the road”, for example, a shape (whether to have a straight shape or a curved shape), a road width, and the like of a travel route of the road are provided. In the case of the curved shape, an R value may be included. In the case of a one-lane road on either side (a road sectioned from an opposite lane), information that specifies the one-lane road on either side is desirably included. As the “gradient”, a direction, an angle, and the like of the gradient are provided. However, the information on the road structure does not have to include all of the “shape of the road”, the “gradient”, the “number of the lanes”, and the “presence or absence of the median strip”, but may only include some of them.

As the mark data 36, candidates that can possibly become marks when the guide intersection is guided (hereinafter referred to as mark candidates) are stored. For example, the facilities that can be identified from a distance (for example, a convenience store, a gas station, a police station, a fire department, and the like), buildings (an office building, an apartment, and the like) that do not correspond to the facilities but have characteristic equipment (for example, a signboard or a parking lot) or external appearance (for example, a color, a material, or size), and the like correspond to the mark candidates. As the mark data 36, information that identifies a location and a type of the mark candidate is stored for each of the mark candidates across the country. Note that, as the mark candidate, only the facility, the building, or the like that is located within a specified range (for example, within 100 m in radius) from the intersection may be stored.

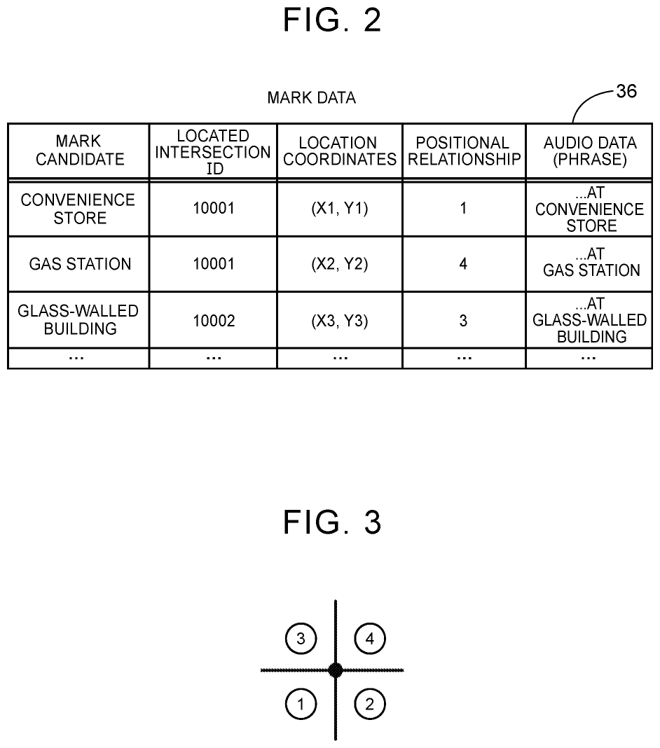

Here, FIG. 2 is a table illustrating examples of the mark data 36 that is stored in the map information DB 31. As illustrated in FIG. 2, in the mark data 36, an intersection ID (only in the case where the mark candidate is located around the intersection), location coordinates at which the mark candidate is located, a relative positional relationship with the intersection, the audio data (may be a phrase representing an audio content) are stored in association with each other for each of the mark candidates. The intersection ID identifies the intersection, around which the mark candidate is located (that is, a guide of the intersection that can be provided using the mark candidate). The audio data is output when the guide is provided using the mark candidate as the mark. The “relative positional relationship with the intersection” is information used to specify in which area the mark candidate is located among plural areas that are acquired by dividing an area around the guide intersection by the roads connected to the guide intersection as illustrated in FIG. 3. The example illustrated in FIG. 3 is the intersection of the four roads. However, shapes and the number of the areas are appropriately changed according to a shape of the intersection such as of three roads or five roads.

For example, FIG. 2 illustrates that the two facilities of the “convenience store” and the “gas station” exist as the mark candidates around the intersection with the ID “10001”. FIG. 2 also indicates that a “glass-walled building” with the characteristic external appearance exists around the intersection with the ID “10002”. Similarly, information on the other mark candidates is also stored. Especially in the case where the facility is used as the mark, instead of a phrase that specifies a broad genre such as the “convenience store” or the “gas station”, a phrase that specifies a genre in a narrower concept may be output. For example, in the case of the convenience store, a phrase that specifies a chain of the convenience store may be output. In such a case, the mark data 36 includes information that specifies the genre in the narrower concept of the mark candidate.

Then, the navigation ECU 13 sets the mark, which is used to provide the guide of the guide intersection located ahead in an advancing direction of the vehicle, on the basis of the mark data 36 stored in the map information DB 31 as will be described later. Thereafter, the navigation ECU 13 generates and outputs the guide of the guide intersection located ahead in the advancing direction of the vehicle on the basis of the set mark. Here, the guide intersection is an intersection as a target of the guide such as a right or left turn command when the navigation system 1 provides a travel guide according to the guide route set in the navigation system 1.

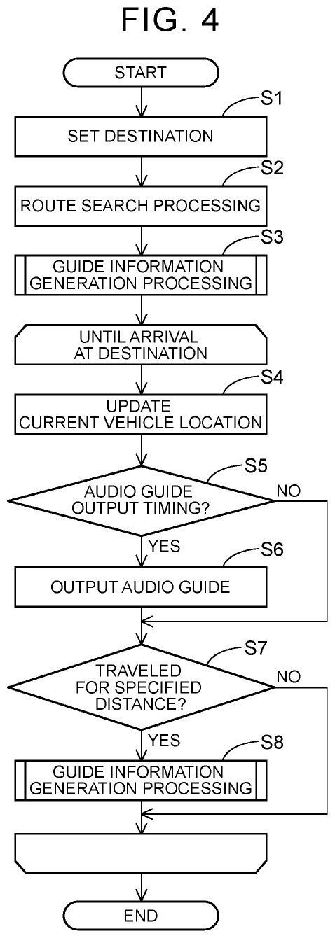

The navigation ECU 13 is an electronic control unit that executes overall control of the navigation system 1 and includes internal storage devices such as: a CPU 41 as an arithmetic device and a controller; RAM 42 that is used as working memory when the CPU 41 executes various types of the calculation processing and that stores route data and the like at the time when the route is searched; ROM 43 that records a control program, a travel guide processing program (FIG. 4), which will be described later, and the like; and flash memory 44 that stores the program read from the ROM 43. Here, the navigation ECU 13 has various means as processing algorithms. For example, a road specifying unit specifies an entry road, from which a movable object (the vehicle) enters the guide intersection, and a leaving road, through which the movable object (the vehicle) leaves the guide intersection, in the case where the movable object (the vehicle) passes the guide intersection along the travel route. A mark determination unit determines the mark that is used to provide the travel guide at the guide intersection on the basis of at least one of a road structure of the entry road and a road structure of the leaving road.

The operation section 14 is operated at the time of entering the point of departure as a travel start point and the destination as a travel end point, and the like, and includes plural operation switches (not illustrated) such as various keys and buttons. Then, the navigation ECU 13 executes control so as to perform any of various types of corresponding operation on the basis of a switch signal that is output when any of the switches is pressed, or the like. Here, the operation section 14 may include a touch screen that is provided on a front surface of the liquid crystal display 15. The operation section 14 may also include a microphone and a voice recognition device.

The liquid crystal display 15 displays a map image including the road, traffic information, an operation guide, an operation menu, a key guide, the guide route from the point of departure to the destination, guide information about the guide route, news, weather forecast, time, e-mails, television programs, and the like. In addition, when the vehicle approaches the guide intersection and the guide intersection is located within a specified distance (for example, 500 m) in the advancing direction of the vehicle, the liquid crystal display 15 also displays an enlarged view of the area near the guide intersection and the advancing direction of the vehicle at the guide intersection. An HUD or an HMD may be used instead of the liquid crystal display 15.

The speaker 16 outputs the audio guidance that provides the travel guide along the guide route and the traffic information guide on the basis of a command from the navigation ECU 13. In particular, in this embodiment, the speaker 16 starts outputting the audio guide, which guides the travel along the guide route, at timing when the vehicle reaches a position where the guide intersection is located within the specified distance (for example, 700 m, 300 m, or 50 m) in the advancing direction of the vehicle. In addition, in the navigation system 1 according to this embodiment, in the case where the appropriate mark that is located ahead in the advancing direction of the host vehicle and that can be recognized visually from the vehicle (the user) passing the guide intersection is present, the speaker 16 outputs the audio guide using the mark. For example, the speaker 16 outputs “Turn right (left) at the intersection with the convenience store.” or the like.

The DVD drive 17 is a drive that can read the data recorded in the recording medium such as the DVD and the CD. Then, on the basis of the read data, the DVD drive 17 plays music or a video, updates the map information DB 31, and the like. Instead of the DVD drive 17, a card slot used to read/write the memory card may be provided.

The communication module 18 is a communicator that receives various types of information such as map update information, assistance information, and the traffic information transmitted from the VTCS® center, the probe center, or the like. For example, a mobile phone or a DCM corresponds to the communication module 18.

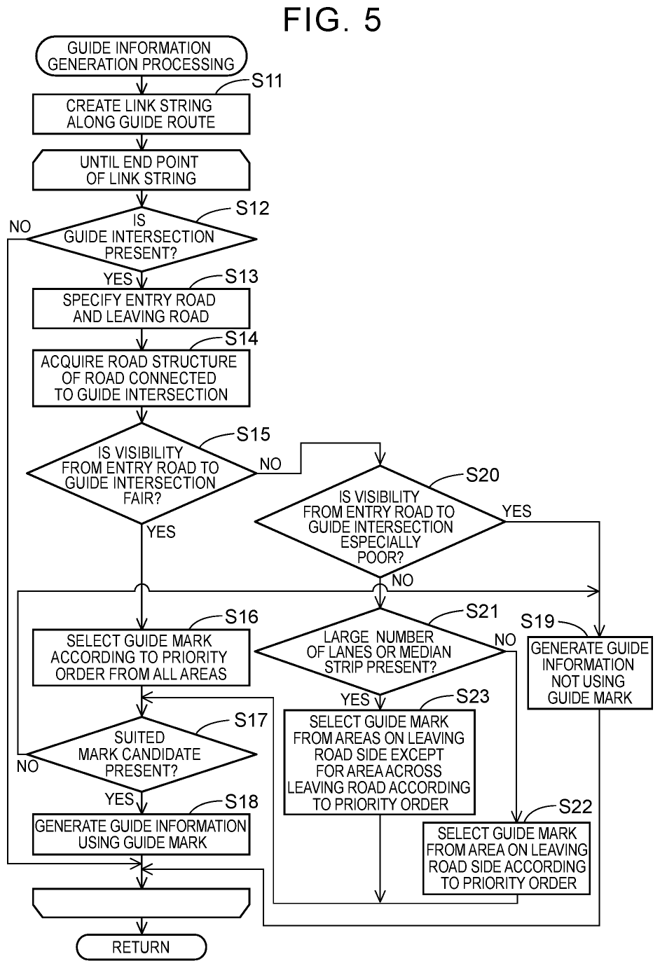

Next, a description will be made on the travel guide processing program that is executed by the navigation ECU 13 in the navigation system 1 having the above configuration with reference to FIG. 5. FIG. 4 is a flowchart of the travel guide processing program according to this embodiment. Here, the travel guide processing program is a program that is executed after an accessory power supply (ACC power supply) of the vehicle is turned ON and that provides the travel guide along the guide route for the vehicle. The program illustrated in the flowcharts of FIG. 4 and FIG. 5 below is stored in the RAM 42 or the ROM 43 provided in the navigation system 1, and is executed by the CPU 41.

First, in the travel guide processing program, in step (hereinafter abbreviated as S) 1, the CPU 41 sets the route destination. Here, the destination is basically set on the basis of the user's operation (for example, a registered point reading operation, a search for the facility, or a facility selection operation) accepted by the operation section 14.

Thereafter, in S2, the CPU 41 uses the map information provided in the navigation system 1 to execute route search processing from the point of departure to the destination set in S1, and specifies a recommended route from the point of departure to the destination. More specifically, the CPU 41 calculates link cost that is acquired by quantifying a degree of appropriateness as the route for the link (the road), intersection cost that is acquired by quantifying a degree of appropriateness as the route for the intersection (the node), monetary cost that is acquired by quantifying an amount of cost required for the travel, and the like, on the basis of link data, node data, the search data, and the like included in the map information, so as to search for the recommended route by using each of the calculated search cost. For example, the CPU 41 uses known Dijkstra's algorithm and sets the route, for which a total of a cost value is minimum, as the recommended route. The route search processing using Dijkstra's algorithm has already been known, and thus a detailed description thereon will not be made. In addition, the current vehicle location may be set as the point of departure, or any point (for example, home) designated by the user may be set as the point of departure. Then, the searched route is set as the guide route in the navigation system 1 on the basis of the user's operation.

The route search processing in S2 may be executed by an external server device instead of the navigation system 1. In such a case, a route search request for requesting the route search is transmitted to the server device, and the recommended route is searched on the basis of the map information provided in the server device. Then, the searched recommended route is received from the server device and is set as the guide route in the navigation system 1 on the basis of the user's operation.

Next, in S3, the CPU 41 executes guide information generation processing (FIG. 5), which will be described later. The guide information generation processing is processing to generate guide information of a section within the specified distance (for example, 3 km) from the current vehicle location along the guide route, and such guide information is used for the vehicle travel guide. In S3, the guide information of the entire route to the destination may be generated instead of the guide information within the specified distance from the current vehicle location. In such a case, processing in S7 and S8, which will be described later, becomes unnecessary.

The processing in S4 to S8 below is repeatedly executed at specified time intervals until the vehicle arrives at the destination. Then, after the vehicle arrives at the destination, the travel guide processing program is terminated.

First, in S4, the CPU 41 specifies the current vehicle location on the basis of a detection result of the current location detection section 11 and the map information. Here, in order to specify the current vehicle location, map matching processing is also executed to match the current vehicle location with the map information.

Thereafter, in S5, the CPU 41 determines whether it is output timing of the audio guide so as to provide the travel guide at the guide intersection. More specifically, timing at which the current vehicle location is 700 m short of the guide intersection, 300 m short thereof, and 50 m short thereof is set as the output timing of the audio guide.

If the CPU 41 determines that it is the output timing of the audio guide so as to provide the travel guide at the guide intersection (S5: YES), the processing proceeds to S6. On the other hand, if the CPU 41 determines that it is not the output timing of the audio guide so as to provide the travel guide at the guide intersection (S5: NO), the processing proceeds to S7.

In S6, the CPU 41 outputs the audio guide corresponding to the current vehicle location from the speaker 16. Here, the audio guide that is output in S6 is the audio data that is generated in the guide information generation processing in S3 in advance or in S8, which will be described later. In the case where text data presenting the audio content is generated instead of the audio data, voice that reads the text data is output from the speaker 16. In particular, in this embodiment, in the case where there is the appropriate mark that can be recognized visually from the vehicle (the user) that passes the guide intersection, the audio guide using the mark is output. A detailed description will later be made on the audio guide using the mark. In addition, in S6, along with the output of the audio guide, the enlarged view of the intersection may be displayed on the liquid crystal display 15. Alternatively, the guide of the guide intersection may be provided not by the voice but a sentence displayed on the liquid crystal display 15.

Next, in S7, the CPU 41 determines whether the vehicle has traveled for a specified distance (for example, 3 km) since timing at which the last guide information generation processing (S3 or S8) is executed. Although the specified distance can appropriately be set, the specified distance is set to 3 km, for example.

If the CPU 41 determines that the vehicle has traveled for the specified distance since the timing at which the last guide information generation processing (S3 or S8) is executed (S7: YES), the processing proceeds to S8. On the other hand, if the CPU 41 determines that the vehicle has not traveled for the specified distance since the timing at which the last guide information generation processing (S3 or S8) is executed (S7: NO), the processing returns to S4.

In S8, the CPU 41 executes the guide information generation processing (FIG. 5), which is the same as that in S3 and will be described later. The guide information generation processing is the processing to generate the guide information of the section within the specified distance from the current vehicle location along the guide route, and such guide information is used for the vehicle travel guide as will be described later. Thereafter, the processing returns to S4.

Next, a description will be made on sub-processing of the guide information generation processing that is executed in S3 and S8 with reference to FIG. 5. FIG. 5 is a flowchart of the sub-processing program for the guide information generation processing.

First, in S11, the CPU 41 creates a link string of the section within the specified distance (for example, within 3 km) from the current vehicle location along the guide route that is set in the navigation system 1 at this time point. The link string is created by using the most detailed link at a level 0.

Next, in S12, the CPU 41 determines, for each of the links contained in the link string created in S11, whether the link is a link for which the guide is necessary, that is, whether an end point corresponds to the guide intersection. More specifically, the intersection that the guide route does not pass in a direction along the road corresponds to the guide intersection. In addition, a special intersection also corresponds to the guide intersection even in the case where the guide route passes the intersection in the direction along the road.

Then, if the CPU 41 determines that the link as a processing target corresponds to the link for which the guide is necessary, that is, if the CPU 41 determines that the end point of the link as the processing target corresponds to the guide intersection (S12: YES), the processing proceeds to S13.

In S13, the CPU 41 first acquires the shape of the guide intersection at the end point of the link as the processing target from the intersection data 35 stored in the map information DB 31. Then, the CPU 41 makes the guide route set in the navigation system 1 and the shape of the guide intersection correspond to each other. In this way, the CPU 41 can specify the road from which the vehicle enters the guide intersection (hereinafter referred to as the entry road) and the road through which the vehicle leaves the guide intersection (hereinafter referred to as the leaving road) when the vehicle passes the guide intersection along the guide route.

In S14, the CPU 41 acquires the road structure of the road, which is connected to the guide intersection located at the end point of the link as the processing target, from the link data 33 stored in the map information DB 31. Here, the road structure includes information that specifies the “shape of the road”, the “gradient”, the “number of lanes”, and the “presence or absence of the median strip”. Furthermore, as the “shape of the road”, for example, information that specifies the road shape of the travel route (whether to have the straight shape or the curved shape), the road width, and the one-lane road on either side (the road sectioned from the opposite lane). The “gradient” includes information that specifies the direction and the angle of the gradient. In S14, not all the roads connected to the guide intersection but only the road structures of the entry road and the leaving road may particularly be acquired. Moreover, elements other than the “shape of the road”, the “gradient”, the “number of lanes”, and the “presence or absence of the median strip” may be included in the road structure.

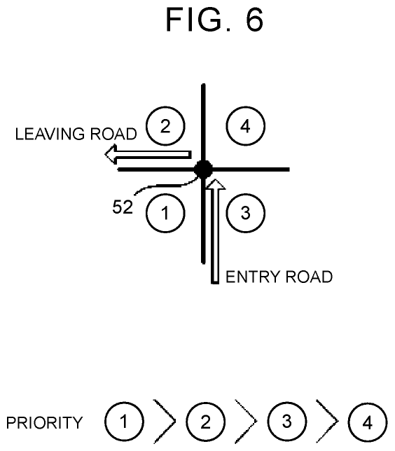

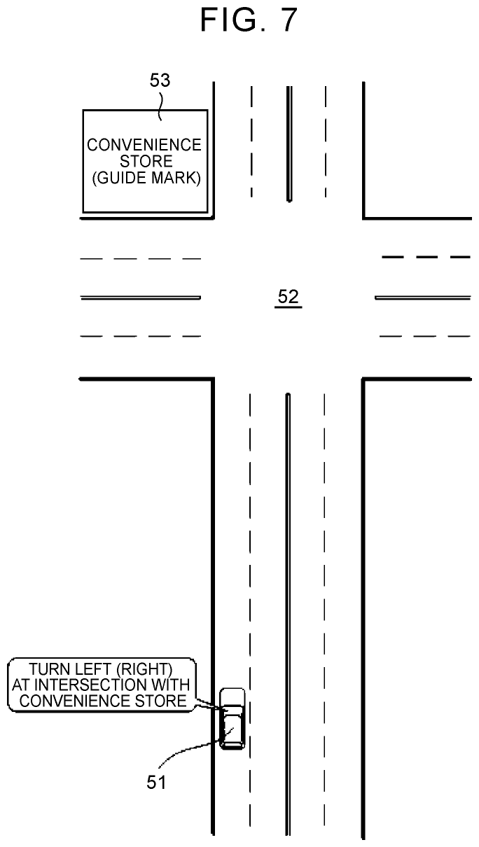

Next, in S15, the CPU 41 determines whether the visibility from the entry road to the guide intersection is in a fair state on the basis of the entry road, which is specified in step S13, to the guide intersection and the road structure of the road that is connected to the guide intersection acquired in S14. Here, the “fair state of the visibility” means that, in the case where an area around a guide intersection 52 is divided by the roads connected to the guide intersection 52 as illustrated in FIG. 6, the mark can easily be recognized visually from the vehicle (the user) that travels the entry road before entering the guide intersection 52 even in the case where which area the mark is located (any of areas [1] to [4] in an example of the guide intersection of the four roads as illustrated in FIG. 6).

More specifically, such a condition is set that any of the following conditions (1) to (3) is satisfied, that the median strip does not exist at least in the entry road and the leaving road, and that the number of the lanes in each of the entry road and the leaving road is equal to or smaller than a specified number (for example, six lanes or less including the opposite lane).

(1) The entry road is a straight road and is downhill.

(2) The road width of the entry road is equal to or narrower than a specified width (for example, 3 m).

(3) The entry road is the one-lane road on either side (the road sectioned from the opposite lane).

Then, if the CPU 41 determines that the visibility from the entry road to the guide intersection is in the fair state (S15: YES), the processing proceeds to S16. On the other hand, if the CPU 41 determines that the visibility from the entry road to the guide intersection is not in the fair state (S15: NO), the processing proceeds to S20.

In S16, the CPU 41 selects the suited mark candidate used for the guide of the guide intersection. More specifically, the CPU 41 refers to the mark data 36 (FIG. 2) included in the map information DB 31, and determines whether one or more mark candidates (that is, the mark candidates that are linked to the guide intersection in the mark data 36) are available around the guide intersection. In S16, it can be estimated that any of the plural areas acquired by sectioning the area around the guide intersection by the roads connected to the guide intersection can be visually recognized from the vehicle (the user) that travels the entry road before entering the guide intersection (that is, the marks in any area can be visually recognized). Accordingly, all of the plural areas that are acquired by sectioning the area around the guide intersection by the roads connected to the guide intersection (as illustrated in FIG. 6, in the example of the guide intersection 52 of the four roads, all the areas [1] to [4]) are set as visually recognizable areas that can be visually recognized from the vehicle (the user). Then, the mark candidates located in the visually recognizable areas are set as guide mark selection candidates as the mark candidates that can be visually recognized from the vehicle (the user). The mark candidate that is selected in S16 will hereinafter be referred to as a guide mark.

Here, in the mark data 36, in the case where the only one mark candidate is available in the visually recognizable area, such a mark candidate serves as the guide mark. Meanwhile, in the case where the plural mark candidates are available in the visually recognizable areas, the guide mark is selected from the plural mark candidates with the following standard.

As illustrated in FIG. 6, of the plural areas that are acquired by sectioning the area around the guide intersection 52 by the roads connected to the guide intersection 52, the area that is located on the entry road side from the guide intersection 52 is set to have a higher priority than the other areas, and the area that is located on the leaving road side from the guide intersection 52 is set to have the higher priority than the others. Then, the mark candidate that is located in the area with the highest priority is selected as the guide mark. Note that which area the mark candidates exist is stored in the mark data 36.

As a result of selecting the guide mark with the above standard, in the case where there are still plural candidates, the mark candidate that is located closest to the guide intersection is selected as the guide mark.

Then, in S17, the CPU 41 considers the visibility of the mark candidate from the vehicle (the user) that travels the entry road before entering the guide intersection. As a result, the CPU 41 determines whether there is the mark candidate that can be visually recognized from the vehicle (the user) that travels on the entry road before entering the guide intersection, that is, whether any of the mark candidates selected in S16 is selected as the guide mark.

Then, if the CPU 41 determines that there are the mark candidates, each of which is located at the position where the vehicle (the user) traveling on the entry road before the guide intersection can visually recognize the mark candidate, and that any of the mark candidates is selected as the guide mark (S17: YES), the processing proceeds to S18. On the other hand, if it is determined that the mark candidate, which is located at the position where the vehicle (the user) traveling on the entry road before the guide intersection can visually recognize the mark candidate, does not exist, and that the mark candidate is not selected as the guide mark (S17: NO), the processing proceeds to S19.

In S18, the CPU 41 decides to provide such a guide that uses the guide mark set in S16 as the guide of the guide intersection at the end point of the link as the processing target. Then, the CPU 41 generates the audio data that is output when the guide intersection is guided. More specifically, the CPU 41 generates the audio data of a guide phrase that includes a phrase used to identify the guide mark. For example, in the case where the “convenience store” is set as the guide mark, the audio data, “Turn left (right) at the intersection with the convenience store” is generated. Here, of the audio data generated in S18, the audio data of the phrase portion used to identify the guide mark is stored in advance in the mark data 36 (FIG. 2). In addition, in S18, instead of generating the audio data itself, the CPU 41 may generate a phrase indicating the audio content.

As a result, for example, as illustrated in FIG. 7, in the case where a facility 53 of the convenience store located in the area around the guide intersection 52 is set as the guide mark at timing at which a vehicle 51 is in a position 700 m or 300 m short of the guide intersection 52, such audio that “Turn left (right) at the intersection with the convenience store” is output.

Meanwhile, in S19, since there is no mark candidate, which is located at the position where the vehicle (the user) traveling on the entry road before the guide intersection can visually recognize the mark candidate, the CPU 41 determines to provide a guide not using the mark as the guide of the guide intersection at the end point of the link as the processing target. As the guide not using the mark, for example, a guide using the distance to the guide intersection is available. Then, the CPU 41 generates the audio data that is output when the guide intersection is guided. For example, such audio data “•• m ahead, turn left (right) at the corner” is generated. In addition, in S15, instead of generating the audio data itself, the CPU 41 may generate the phrase indicating the audio content.

In addition, in S20, the CPU 41 determines whether the visibility from the entry road to the guide intersection is in an especially poor state on the basis of the entry road, which is specified in step S13, to the guide intersection and the road structure of the road that is connected to the guide intersection acquired in S14. Here, the “especially poor visibility state” means that, in any of the plural areas that are acquired by sectioning the area around the guide intersection by the roads connected to the guide intersection, it is difficult to visually recognize the guide mark from the vehicle (the user) that travels the entry road before entering the guide intersection, that is, it is in a state where the mark in any area is difficult to be visually recognized.

More specifically, the following condition (4) or (5) has to be satisfied.

(4) The entry road is the uphill gradient.

(5) The entry road is the curved road (however, a gentle curve, the R value of which is equal to or higher than a threshold (for example, 1000 m or more) may be regarded as the straight road.)

Then, if the CPU 41 determines that the visibility from the entry road to the guide intersection is in the especially poor state (S20: YES), the processing proceeds to S19. In S19, as described above, the guide not using the mark is decided as the guide of the guide intersection at the end point of link as the processing target. On the other hand, if the CPU 41 determines that the visibility from the entry road to the guide intersection is not in the especially poor state (S20: NO), the processing proceeds to S21.

In S21, the CPU 41 determines whether at least one of the entry road and the leaving road is the road with the median strip or a road with specified number of lanes or more (for example, seven lanes or more including the opposite lane) on the basis of the entry road to and the leaving road from the guide intersection specified in S13 and the road structure of the road, which is connected to the guide intersection, and is acquired in S14.

Then, if the CPU 41 determines that there is no median strip between the entry road and the leaving road, and the number of the lanes of the road is smaller than the specified number (S21: NO), the processing proceeds to S22. On the other hand, if the CPU 41 determines that there is the median strip in at least one of the entry road and the leaving road, or determines that the number of the lanes of the road is equal to or larger than the specified number (S21: YES), the processing proceeds to S23.

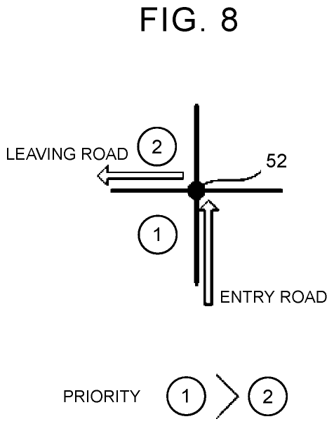

In S22, the CPU 41 selects the suited mark candidate used for the guide of the guide intersection. More specifically, the CPU 41 refers to the mark data 36 (FIG. 2) included in the map information DB 31, and determines whether at least one mark candidate (that is, the mark candidate that is linked to the guide intersection in the mark data 36) is available around the guide intersection. Here, in S22, it is estimated that, of the plural areas that are acquired by sectioning the area around the guide intersection by the roads connected to the guide intersection, in particular, the areas on the leaving road side from the guide intersection (hereinafter referred to as leaving-side areas) can be visually recognized by the vehicle (the user) that traveling on the entry road before the guide intersection (that is, the marks on the leaving-side areas can be visually recognized). Accordingly, the leaving-side areas (as illustrated in FIG. 8, the areas [1] to [2] in the example of the guide intersection of the four roads) are set as the visually recognizable areas that can be visually recognized by the vehicle (the user). Then, the mark candidates located in the visually recognizable areas are set as the guide mark selection candidates as the mark candidates that can be visually recognized from the vehicle (the user). The mark candidate that is selected in S22 will also be referred to as a guide mark in the same manner as in S16.

Here, in the mark data 36, in the case where the only one mark candidate is available in the visually recognizable area, such a mark candidate serves as the guide mark. Meanwhile, in the case where the plural mark candidates are available in the visually recognizable areas, the guide mark is selected from the plural mark candidates according to the following standard.

As illustrated in FIG. 8, of the plural areas that are acquired by sectioning the area around the guide intersection 52 by the roads connected to the guide intersection 52, the area that is located on the entry road side from the guide intersection 52 is set to have higher priority than the other area. Then, the mark candidate that is located in the area with the high priority is selected as the guide mark. Note that which area the mark candidates exist is stored in the mark data 36.

As a result of selecting the guide mark with the above standard, in the case where there are still plural candidates, the mark candidate that is located closest to the guide intersection is selected as the guide mark.

Thereafter, the processing proceeds to S17. Then, it is determined, on the basis of the consideration result of the visibility from the vehicle (the user) traveling the entry road before the guide intersection, whether there is the mark candidate, which is located the position where the vehicle (the user) traveling the entry road before the guide intersection can visually recognize the mark candidate, that is, it is determined whether any of the mark candidates is selected as the guide mark in S22. Then, if it is determined that any of the mark candidates is selected as the guide mark, the guide information using the selected guide mark is generated (S18).

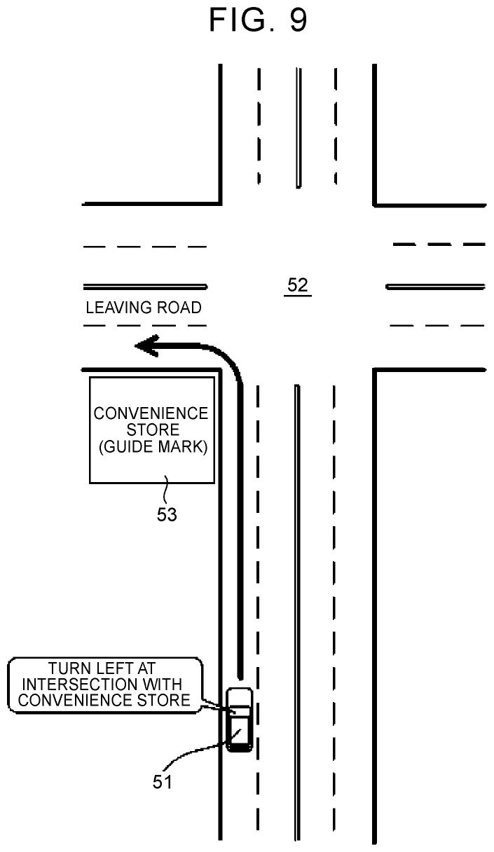

As a result, for example, as illustrated in FIG. 9, in the case where the facility 53 of the convenience store located around the guide intersection 52 is set as the guide mark, the audio guide, “Turn left (right) at the intersection with the convenience store”, is output at the timing when the vehicle 51 is in the position 700 m or 300 m short of the guide intersection 52. In this case, the facility 53 of the convenience store as the guide mark is located on the leaving road side area from the guide intersection. Thus, even in the case where the guide intersection 52 is not the intersection with the fair visibility, it is possible to appropriately visually recognize the guide mark from the vehicle (the user) that travels the entry road before entering the guide intersection 52.

Meanwhile, in S23, the CPU 41 selects the suited mark candidate used for the guide of the guide intersection. More specifically, the CPU 41 refers to the mark data 36 (FIG. 2) included in the map information DB 31, and determines whether one or more mark candidates (that is, the mark candidates that are linked to the guide intersection in the mark data 36) is available around the guide intersection. Here, in S23, it is estimated that the vehicle (the user) that travels the entry road before entering the guide intersection can visually recognize the leaving-side areas (that is, can visually recognize the mark in the areas) except for the area that is visually recognized across the entry road and the leaving road, each of which is determined that the median strip is provided or the number of the lanes is equal to or larger than the specified number.

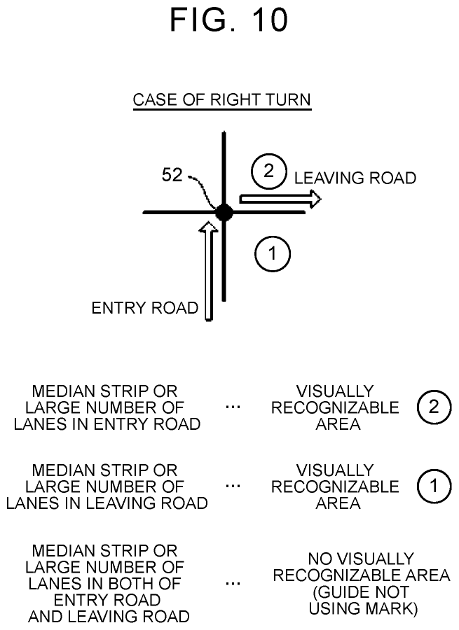

Thus, as illustrated in FIG. 10, in the case where the vehicle turns to the right at the guide intersection 52, where the median strip is only provided in the entry road, or the number of the lanes is equal to or larger than the specified number, the area [2] is set as the visually recognizable area. Meanwhile, in the case where the median strip is only provided in the leaving road, or the number of the lanes is equal to or larger than the specified number, the area [1] is set as the visually recognizable area. Furthermore, in the case where the median strips are provided on both of the entry road and the leaving road, or the number of the lanes is equal to or larger than the specified number, the visually recognizable area is absent.

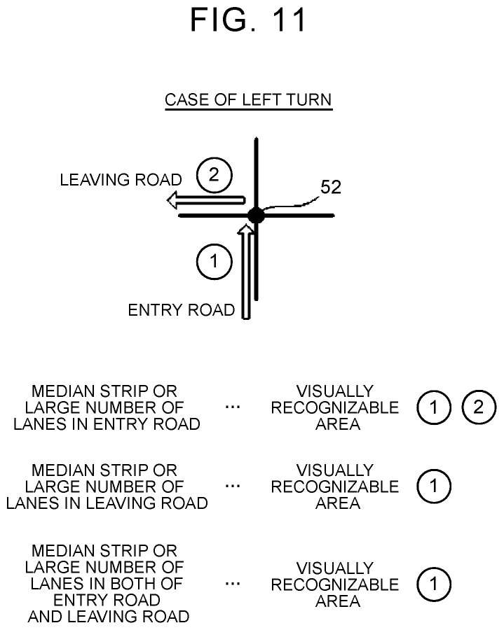

As illustrated in FIG. 11, in the case where the vehicle turns to the left at the guide intersection 52, where the median strip is only provided in the entry road, or the number of the lanes is equal to or larger than the specified number, the areas [1] and [2] are set as the visually recognizable areas. Meanwhile, in the case where the median strip is only provided in the leaving road, or the number of the lanes is equal to or larger than the specified number, the area [1] is set as the visually recognizable area. Furthermore, in the case where the median strips are provided on both of the entry road and the leaving road, or the number of the lanes is equal to or larger than the specified number, the area [1] is set as the visually recognizable area.

Then, as the mark candidate that can be visually recognized from the vehicle (the user), the mark candidate located in the visually recognizable area serves as the selection candidate of the guide mark. The mark candidate selected in S23 will also be referred to as the guide mark as in S16 and S22.

Here, in the mark data 36, in the case where there is only one mark candidate in the visually recognizable area, such a mark candidate serves as the guide mark. On the contrary, in the case where there are the plural mark candidates in the visually recognizable area, the guide mark is selected according to the same standard as in S22.

Thereafter, the processing proceeds to S17. Then, it is determined, on the basis of the consideration result of the visibility from the vehicle (the user) traveling the entry road before the guide intersection, whether there is the mark candidate, which is located the position where the vehicle (the user) can visually recognize the mark candidate, that is, it is determined whether any of the mark candidates is selected as the guide mark in S23. Then, if it is determined that any of the mark candidates is selected as the guide mark, the guide information using the selected guide mark is generated (S18).

As a result, for example, as illustrated in FIG. 9, in the case where the facility 53 of the convenience store located around the guide intersection 52 is set as the guide mark, the audio guide, “Turn left (right) at the intersection with the convenience store”, is output at the timing when the vehicle 51 is located at a position 700 m or 300 m short of the guide intersection 52. In this case, even in the case where at least one of the entry road and the leaving road has the large number of the lanes or has the median strip, the vehicle (the user) traveling on the entry road before the guide intersection 52 can appropriately and visually recognize the facility 53 of the convenience store as the guide mark.

On the other hand, if it is determined that the link as the processing target does not correspond to the link for which the guide is necessary (S12: NO), the link as the processing target is switched. Then, after the processing in S12 to S23 is terminated for all of the links provided in the link string created in S11, the processing proceeds to S4.

As it has been described so far in detail, according to the navigation system 1 of the embodiment and the computer program executed by the navigation system 1, in the case where the vehicle travel guide is provided along the guide route and the vehicle passes the guide intersection along the guide route, the entry road that enters the guide intersection and the leaving road that leaves from the guide intersection are specified (S13), the mark used for the travel guide at the guide intersection is determined on the basis of at least one of the road structure of the entry road and the road structure of the leaving road (S15 to S23). Thus, it is possible to decide the mark while considering the visibility of the mark on the basis of the road structure of peripheral roads at the guided intersection. As a result, it is possible to provide the travel guide of the guide intersection by using the further appropriate mark.

The disclosure is not limited to the embodiment, and it is needless to say that various improvements and modifications can be made thereto within the scope that does not depart from the gist of the disclosure. For example, in this embodiment, the information on the mark candidate that serves as the candidate for the mark at the time when the guide intersection is guided and the information on the road structure of the road connected to the guide intersection are acquired from the map information DB 31 provided in the navigation system 1. However, such information may be acquired from the external server. Furthermore, in the case where the map information itself is acquired from the external server, the map information DB 31 can be omitted from the navigation system 1.

In this embodiment, the facilities or the buildings of (1) and (2) above are described as the mark candidates. However, the elements other than (1) and (2) can also be included as the mark candidates. For example, a traffic light, a railway crossing, a road sign, and the like may be included in the mark candidates.

In this embodiment, both of the road structure of the entry road and the road structure of the leaving road are used to specify the visually recognizable area (S22, S23, FIG. 10, and FIG. 11), and the mark candidate located within the visually recognizable areas is specified as the guide mark. However, the visually recognizable area may be specified only by using the road structure of the entry road. In such a case, for example, the area [2] illustrated in FIG. 10 and FIG. 11 may always be included in the visually recognizable area or may always be excluded from the visually recognizable area. Similarly, only the road structure of the leaving road may be used to specify the visually recognizable area. In such a case, for example, the area [1] illustrated in FIG. 10 and FIG. 11 may always be included in the visually recognizable area or may always be excluded from the visually recognizable area.

In addition to the navigation system, the disclosure can be applied to various devices, each of which has a function of providing the travel guide based on the guide route. For example, the disclosure can also be applied to mobile terminals, such as a mobile phone and a smartphone, a personal computer, a tablet terminal, and the like (hereinafter referred to as the mobile terminal and the like). In such a case, in addition to the vehicle travel guide, the travel guide can also be provided in the case where the user travels by foot or by bicycle.

The disclosure can also be applied to a system that is constructed of the navigation system 1 and the server or of the mobile terminal or the like and the server. In such a case, it may be configured that some of the steps in the above-described travel guide processing program (FIG. 4 and FIG. 5) are executed by the server. For example, the server may execute the route search processing (S2) and the guide information generation processing (S3, S8).

The description has been made on the embodiment in which the travel guide system and the computer program according to the disclosure are embodied. However, the travel guide system can also have the following configuration and, in such a case, exhibits the following effects.

For example, a first configuration is as follows. A travel guide system (1) that uses the mark (53) located around the travel route of the movable object (51) so as to provide the travel guide for the movable object at the guide intersection (52) includes: the road specifying unit (41) that specifies the entry road, from which the movable object enters the guided intersection, and the leaving road, through which the movable object leaves the guide intersection, in the case where the movable object passes the guide intersection along the travel route; and the mark determination unit (41) that determines the mark used to provide the travel guide at the guide intersection on the basis of at least one of the road structure of the entry road and the road structure of the leaving road. According to the travel guide system having the above configuration, the mark used to provide the travel guide at the guide intersection is determined on the basis of at least one of the road structure of the entry road and the road structure of the leaving road at the time when the movable object passes the guide road. Thus, it is possible to determine the mark while considering the visibility of the mark on the basis of the road structure of the road around the guide intersection. As a result, it is possible to provide the travel guide of the guide intersection by using the further appropriate mark.

For example, a second configuration is as follows. The mark determination unit (41) determines the mark (53), which is located at the position where the movable object (51) before entering the guide intersection (52) can visually recognize the mark (53), as the mark used for the travel guide at the guide intersection. According to the travel guide system having the above configuration, the mark, which is located at the position where the movable object can visually recognize the mark, is determined as the mark used for the travel guide on the basis of at least one of the road structure of the entry road and the road structure of the leaving road at the time when the movable object passes the guide road. Thus, it is possible to provide the guide of the guide intersection while the mark is reliably and visually recognized from the movable object passing the intersection.

For example, a third configuration is as follows. The mark determination unit (41) specifies the area, which can be visually recognized from the movable object (51) before entering the guide intersection, of the plural areas acquired by sectioning the area around the guide intersection (52) by the roads connected to the guide intersection on the basis of at least one of the road structure of the entry road and the road structure of the leaving road, and sets the mark (53) located within the specified area as the mark, which is located at the position where the movable object before entering the guide intersection can visually recognize the mark. According to the travel guide system having the above configuration, the area, which can be visually recognized from the movable object, is specified on the basis of at least one of the road structure of the entry road and the road structure of the leaving road at the time when the movable object passes the guide road. In this way, it is possible to easily specify the mark, which is located at the position where the movable object can visually recognize the mark.

For example, a fourth configuration is as follows. The mark determination unit (41) determines not to use the mark for the travel guide at the guide intersection in the case where the mark (53), which is located at the position where the movable object (51) before entering the guide intersection (52) can visually recognize the mark, does not exist. According to the travel guide system having the above configuration, in the case where the mark, which is located at the position where the movable object before entering the guide intersection can visually recognize the mark, does not exist, the guide is provided without using the mark on the basis of at least one of the road structure of the entry road and the road structure of the leaving road at the time when the movable object passes the guide road. Thus, it is possible to prevent erroneous recognition of the guide intersection.

For example, a fifth configuration is as follows. In the case where there are the plural marks (53), each of which is located at the position where the movable object (51) before entering the guide intersection (52) can visually recognize the mark, the mark determination unit (41) sets the priority of the plural areas, which are acquired by sectioning the area around the guide intersection by the roads connected to the guide intersection, on the basis of the combination of the entry road, from which the movable object enters the guide intersection, and the leaving road, through which the movable object leaves the guide intersection. Then, of the plural marks, the mark determination unit (41) preferentially selects the mark, which is located in the area with the high priority, as the mark used for the travel guide at the guide intersection. According to the travel guide system having the above configuration, also in the case where there are the plural marks as the candidates, the priority of the areas where marks are located is determined, and thus it is possible to provide the guide of the guide intersection using the mark, which is located at the position where the movable object can further easily recognize the mark.

For example, a sixth configuration is as follows. Of the plural areas that are acquired by sectioning the area around the guide intersection (52) by the roads connected to the guide intersection, the mark determination unit (41) sets the area located on the entry road side from the guide intersection to have the higher priority than the other areas. In addition, of the plural areas that are acquired by sectioning the area around the guide intersection by the roads connected to the guide intersection, the mark determination unit (41) sets the area located on the leaving road side from the guide intersection to have the higher priority than the other areas. According to the travel guide system having the above configuration, also in the case where there are the plural marks as the candidates, it is possible to provide the guide of the guide intersection using the mark, which is selected according to the combination of the entry road and the leaving road and which is located at the position where the movable object can further easily recognize the mark.

For example, a seventh configuration is as follows. The road structure includes at least one of the shape of the road, the gradient of the road, the number of the lanes, and the presence or the absence of the median strip. According to the travel guide system having the above configuration, it is possible to determine the mark in consideration of the visibility of the mark that is influenced by the shape of the road, the gradient of the road, the number of the lanes, and the presence or the absence of the median strip. As a result, it is possible to provide the travel guide of the guide intersection using the further appropriate mark.

1. A travel guide system that provides a movable object with a travel guide at a guide intersection by using a mark located around a travel route of the movable object, the travel guide system comprising:
a road specifying unit that specifies an entry road, from which the movable object enters the guide intersection, and a leaving road, through which the movable object leaves the guide intersection, in the case where the movable object passes the guide intersection along the travel route; and
a mark determination unit that determines the mark used for the travel guide at the guide intersection on the basis of at least one of a road structure of the entry road and a road structure of the leaving road.

2. The travel guide system according to claim 1, wherein
the mark determination unit determines the mark, which is located at a position where the movable object before entering the guide intersection can visually recognize the mark, as a mark used for the travel guide at the guide intersection.

3. The travel guide system according to claim 2, wherein
the mark determination unit:
specifies an area, which can be visually recognized from the movable object before entering the guide intersection, of plural areas acquired by sectioning an area around the guide intersection by roads connected to the guide intersection on the basis of at least one of the road structure of the entry road and the road structure of the leaving road, and
sets the mark located within the specified area as the mark, which is located at the position where the movable object before entering the guide intersection can visually recognize the mark.

4. The travel guide system according to claim 2, wherein
the mark determination unit determines not to use the mark for the travel guide at the guide intersection in the case where the mark, which is located at the position where the movable object before entering the guide intersection can visually recognize the mark, does not exist.

5. The travel guide system according to claim 2, wherein
in the case where there are the plural marks, each of which is located at the position where the movable object before entering the guide intersection can visually recognize the mark, the mark determination unit:
sets priority of the plural areas, which are acquired by sectioning the area around the guide intersection by roads connected to the guide intersection, on the basis of a combination of the entry road, from which the movable object enters the guide intersection, and the leaving road, through which the movable object leaves the guide intersection, and
preferentially selects the mark, which is located in the area with the highest priority, of the plural marks as the mark used for the travel guide at the guide intersection.

6. The travel guide system according to claim 5, wherein
the mark determination unit
sets an area on the entry road side from the guide intersection as an area with a higher priority than the other areas among the plural areas that are acquired by sectioning the area around the guide intersection by roads connected to the guide intersection, and
sets an area on the leaving road side from the guide intersection as an area with a higher priority than the other areas among the plural areas that are acquired by sectioning the area around the guide intersection by roads connected to the guide intersection.

7. The travel guide system according to claim 1, wherein
the road structure includes at least one of a shape of a road, a gradient of the road, number of lanes, and presence or absence of a median strip.

8. A computer program that makes a computer function as,
in the case where a travel guide at a guide intersection is provided for a movable object using a mark that is located around a travel route of the movable object:
a road specifying unit that specifies an entry road, from which the movable object enters the guide intersection, and a leaving road, through which the movable object leaves the guide intersection, in the case where the movable object passes the guide intersection along the travel route; and
a mark determination unit that determines the mark used for the travel guide at the guide intersection on the basis of at least one of a road structure of the entry road and a road structure of the leaving road.
